(19) United States
(12) Patent Application Publication
(10) Pub. No.: US 2024/0150904 A1
(43) Pub. Date: May 9, 2024

(54) A DEVICE AND A METHOD FOR PRODUCING HYDROGEN

(71) Applicant: Global Warming Solutions, Inc., Temecula, CA (US)

(72) Inventor: Artem Madatov, Rockville, MD (US)

(21) Appl. No.: 18/552,633

(22) PCT Filed: Mar. 28, 2021
(86) PCT No.: PCT/US2021/024546

§ 371 Date: Sep. 26, 2023

(51) Int. Cl. C25B 1/02; C25B 5/00; C25B 9/19; C25B 9/60; C25B 9/65; C25B 11/043; C25B 11/046; C25B 15/00

(52) U.S. Cl. CPC C25B 1/02; C25B 5/00; C25B 9/19; C25B 9/60; C25B 9/65; C25B 11/043; C25B 11/046; C25B 15/00

(57) ABSTRACT

The invention relates to the energy industry, in particular to a device and a method for producing hydrogen, and can be used, for example, as a part of fuel systems of various vehicles in order to supply fuel to a hydrogen engine or hydrogen fuel cells. In the first aspect, the claimed invention is a device for producing hydrogen, comprising a housing and at least one rechargeable electrolytic cell with electrodes, which is mounted in the housing, the electrodes being an anode and a cathode, the cell being at least partially filled with a liquid water-based electrolyte, wherein the device comprises a sodium electrode isolated from the liquid electrolyte by a solid electrolyte configured to exchange positively charged sodium ions with the liquid electrolyte, and the cathode and the anode are separated by an ion-permeable partition. In the second aspect, the claimed invention is a method for producing hydrogen by alternating the discharging and charging processes of a rechargeable electrolytic cell.

### FIELD OF THE INVENTION

The invention relates to the energy industry, in particular to a device and a method for producing hydrogen, and can be used, for example, as a part of fuel systems of various vehicles in order to supply fuel to a hydrogen engine or hydrogen fuel cells.

### STATE OF THE ART

Vehicles powered by various types of energy are known from the prior art. As known, there is a problem associated with air pollution by exhaust gases of the vehicles using the energy of combustion of hydrocarbon fuel. The vehicles powered exclusively by electrical energy, in turn, do not have such a problem, however, the low capacity, short service life and high cost of electrical energy batteries lead to the necessity to search for other types of fuel and methods to store energy on board of a vehicle.

One of the well-known sources of “clean” energy is hydrogen, since the oxidation of hydrogen with atmospheric oxygen produces only water. Moreover, the calorific value of hydrogen is extremely high—141 mJ/kg. Consequently, for a passenger car to travel a distance of about 750 miles (1200 km) only 3 kg of hydrogen is required. The problem associated with using hydrogen fuel resides in the danger and the inconvenience of storing it on board of a vehicle. For example, to store a specified amount of hydrogen in a cylinder at normal temperature, a pressure of more than 60 MPa is required. On the other hand, it is no less dangerous to store hydrogen on board in a liquid state, because its storage requires maintaining a low temperature of −253° C. When the temperature rises, it boils continuously, owing to which it is necessary to release the evaporated hydrogen to the atmosphere at parking lots, which is extremely fire hazardous.

A safer way to power a vehicle engine by hydrogen is not to store the entire supply of hydrogen on board, but to produce it as it is consumed. Various methods for producing hydrogen from water are known from the prior art, one of which is to use electric current to decompose water. For example, the patent of the Russian Federation No. 2493292 (publ. Sep. 20, 2013) describes a device for water electrolysis, comprising a solid polymer electrolyzer with pneumatically isolated chambers for hydrogen and oxygen, connected to a power supply unit, which is electrically connected to the process parameter control system, as well as a water supply system with a stock of reaction water, including hydrogen/oxygen gas separators, connected to the corresponding chambers of the electrolyzer by their input and output hydraulic lines and equipped with pneumatic lines with shut-off elements.

The disadvantage of the device is the need to supply electrical energy from an external source to reduce hydrogen from water, which makes it impossible to use the device when a car is on the move. In addition, direct electrolysis of water is accompanied by a significant overvoltage at the cathode with the release of gaseous hydrogen and, as a consequence, an increased consumption of electrical energy. Therefore, the overall efficiency of the energy cycle of hydrogen production and its use as an energy carrier does not exceed 40%. In this case excess electrical energy is converted into heat energy and heats up the electrolyte. This, in turn, causes the electrolyte to be forcibly cooled, preventing it from boiling.

It is known that electrolytic separation of metals is usually not accompanied by a large overvoltage at the cathode and, therefore, is energetically more favorable than the direct production of hydrogen. In view of this, there are solutions which propose to first reduce by electric current metals active in relation to water (for example, aluminum, magnesium, alkali metals), and then to dissolve them in a separate reactor in aqueous electrolytes, obtaining hydrogen for energy needs. For example, the patent of the Russian Federation No. 2520490 (publ. Jun. 27, 2004) describes a method for producing hydrogen by dissolving aluminum in pure water. To do this, it is proposed to remove the oxide film on aluminum, which prevents the reaction, by a high-voltage high-frequency spark discharge, applying a voltage of up to 100 kV to aluminum.

The disadvantages of the described method are the need to transport aluminum from the place of its production to the place of consumption, load it into the reactor in the form of pieces of a certain shape (shaving) and clean the reactor from aluminum hydroxide after the end of the process. All these operations can only be performed manually by qualified personnel.

The international application No. 2017041190 (publ. Mar. 16, 2017) describes a method for producing hydrogen by bringing into contact a proton-donor liquid, in particular water, and a metal that can be selected from a list including, but not limited to, sodium. The international application No. 2010140873 (publ. Dec. 9, 2010) discloses a method for renewable production of hydrogen using regenerable basic materials, including the reaction of an alkali metal with water, the removal of the produced hydrogen from the reaction vessel for direct use, and the subsequent regeneration of an alkali metal from the produced hydroxide, wherein the dosed water is fed to the vessel containing the alkali metal for a controlled reaction with the alkali metal, and the formed alkali metal hydroxide is regenerated by electrolysis. The described methods are methods for producing hydrogen directly as a result of a reaction between an active metal and water. The energy released in the described methods is converted into heat; it cannot be converted into useful work by means of the described methods, which is a significant disadvantage. In addition, these methods are realized using only a stationary electrical network.

There is known a method for producing hydrogen, when a car is on the move, by reducing hydrogen from water using an active metal, namely, lithium. The international application No. 2005033366 (publ. Apr. 14, 2015) describes a method for dissolving liquid lithium in an electrolyte (molten lithium hydroxide) with dosed saturation of the melt with water vapor. The temperature at which the electrolyte is in a liquid state is +350° C. Lithium is in the form of an eutectic solution in an alloy of heavy metals (lead, tin, bismuth and cadmium), which is in the form of a melt layer at the bottom of the metal bath. Lithium dissolves to form lithium hydroxide and releases hydrogen. When the device is charged with a constant electric current from the network, lithium hydroxide decomposes into oxygen, water and metallic lithium, which accumulates in the cathode space. Oxygen and water vapor are released at the stainless steel anode. The water is condensed in the refrigerator and accumulated for reuse.

The disadvantages of the prototype include: the high operating temperature (+350° C.), the need for preliminary heating of the electrolyte, the difficulty of controlling the hydrogen evolution process by dosed supply of water vapor. In addition, a small difference in the density of molten lithium and its hydroxide melt forces to use lithium in an alloy with heavy metals so that lithium remains at the bottom of the bath when a car is on the move (it does not mix with the electrolyte). However, heavy metals are toxic, expensive and increase the weight of a device. In addition, the difference between the standard electrode potentials of lithium and hydrogen is about 3 V. When hydrogen is directly reduced on the lithium surface, the energy of this potential difference is converted into heat. As a result, only half of the energy stored in the course of reduction of lithium is used as a chemical energy of hydrogen. Moreover, lithium is a scarce material, global production thereof is low, and the market price cannot be reduced in the coming years.

The US patent application No. 2002012848 (publ. Jan. 31, 2002) describes an electrolytic cell made of three electrode assemblies placed in a housing. One of the electrodes is a negative electrode or a metal anode; the second electrode is a positive electrode, that is, an air cathode; and the third electrode is a porous charge electrode. The electrolytic cell can also include a liquid (aqueous) electrolyte being in contact with each electrode by immersion therein, a membrane with a polymer matrix and a porous spacer.

The disadvantages of the described solution include the inability to recharge the device, the expensiveness of the device due to the high cost of lithium used in the design of one of the electrodes, the inability to recover said electrode, the inability to maintain the device charge for a long time, which in turn affects its autonomy, as well as susceptibility of said electrode to corrosion caused by contacting with a liquid water-based electrolyte, which has a negative impact on the durability of the known solution.

Thus, the present-day task is to develop an autonomous, safe, cheap, durable and compact device for producing hydrogen, the design of which would allow it to be recharged by recovering the electrode, which is a source of electrons for hydrogen generation, at a normal (room) temperature, would prevent the corrosion of the electrode, which occurs during contact with a liquid water-based electrolyte, and would ensure that the device retains its charge for a long time. Accordingly, the present-day task is also to create such a method for producing hydrogen that would provide for the degree of safety and ease of realization required for common use, in particular, by allowing it to be realized at a normal (room) temperature and allowing the rate of hydrogen release to be regulated, and would allow the electrode, which is a source of electrons for hydrogen generation, to be recovered.

### SUMMARY OF THE INVENTION

The problem of the prior art according to the present invention is solved by developing a device and a method for producing hydrogen.

In the first aspect, the claimed invention is a device for producing hydrogen, comprising a housing and at least one rechargeable electrolytic cell with electrodes, which is mounted in the housing, the electrodes being an anode and a cathode, the cell being at least partially filled with a liquid water-based electrolyte, wherein the device comprises a sodium electrode isolated from the liquid electrolyte by a solid electrolyte configured to exchange positively charged sodium ions with the liquid electrolyte, and the cathode and the anode are separated by an ion-permeable partition.

In the second aspect, the claimed invention is a method for producing hydrogen by alternating the discharging and charging processes of a rechargeable electrolytic cell with electrodes, at least partially filled with a liquid water-based electrolyte, wherein a sodium electrode isolated from the liquid electrolyte by a solid electrolyte configured to exchange positively charged sodium ions with the liquid electrolyte, a cathode and an anode are used as electrodes, wherein the passage of electrons from the sodium electrode to the cathode is provided in the discharging process to release hydrogen at the cathode, and the transfer of electrons from the anode to the sodium electrode is provided in the charging process to recover the sodium electrode by passing an electric current through the anode and the sodium electrode, wherein the cathode and the anode are separated by means of an ion-permeable partition.

This summary of the invention is provided in a simplified form as a reference for the inventive concept, which is further disclosed below in the detailed description of the invention. This summary of the invention is not intended to identify the essential features of the claimed subject matters of the invention and is not intended to be used to limit the claimed protection scope of the invention.

### BRIEF DESCRIPTION OF THE DRAWINGS

FIG. 1 is a general view of an electrolytic cell in a discharging process.

FIG. 2 is a general view of an electrolytic cell in a charging process.

FIG. 3 is an example of an implementation of a sodium electrode (a is a sodium electrode in a charged state, b is a sodium electrode in a discharged state).

FIG. 4 is a schematic example of combining a device for producing hydrogen with a stack of fuel cells in a car.

FIG. 5 is a schematic example of combining a device for producing hydrogen with the use of hydrogen in stationary energy storage units.

### DETAILED DESCRIPTION OF THE INVENTION

The present invention provides a device for producing hydrogen, comprising a housing and at least one rechargeable electrolytic cell with electrodes, which is mounted in the housing, the electrodes being an anode and a cathode, the cell being at least partially filled with a liquid water-based electrolyte, wherein the device comprises a sodium electrode isolated from the liquid electrolyte by a solid electrolyte configured to exchange positively charged sodium ions with the liquid electrolyte, and the cathode and the anode are separated by an ion-permeable partition.

Thus, the sodium electrode is a bifunctional sodium electrode serving as an anode when the cell is discharging and serving as a cathode when the cell is charging, wherein the cathode is a cathode, at which hydrogen is released during the passage of electrons from the bifunctional sodium electrode to the cathode when the cell is discharged, and the anode is an anode that donates electrons to be transferred to the bifunctional sodium electrode when the cell is charged.

Thus, the bifunctional sodium electrode takes part both in the discharging, and in the charging of the electrolytic cell. In contrast, the anode and the cathode take part in the operation of the device alternately, while the cathode is used when discharging and the anode is used when charging in a pair with the bifunctional sodium electrode. It is also worth noting that the anode is an electrode characterized by the fact that the movement of electrons in the external circuit is directed away from it, whereas the cathode is an electrode characterized by the fact that the movement of electrons in the external circuit is directed towards it. Thus, when the electrolytic cell is discharging, electrons pass through the external circuit from the bifunctional sodium electrode serving as an anode to the cathode. When it is charging, electrons pass through the external circuit from the anode to the bifunctional sodium electrode serving as a cathode. In this case, the anode is an anode made of a chemically inert material that donates electrons to be transferred to the bifunctional sodium electrode. The bifunctional sodium electrode is isolated from the liquid electrolyte by a solid electrolyte, i.e., it does not come into contact with the liquid water-based electrolyte. Isolating the bifunctional sodium electrode from the liquid electrolyte prevents its corrosion, which occurs during contact with the liquid water-based electrolyte. Thus, a spontaneous oxidation of the bifunctional sodium electrode with the transfer of electrons to the molecules of water (of the liquid water-based electrolyte) does not occur in the discharging process of the electrolytic cell, release of hydrogen at the bifunctional sodium electrode does not occur either. Instead, electrons flow through the external circuit closed between the bifunctional sodium electrode and the cathode, wherein hydrogen is released at the cathode. It should be noted that the discharging of the electrolytic cell (dissolution of the bifunctional sodium electrode) and release of hydrogen occur only when the external electrical circuit is closed, when the electrons from the bifunctional sodium electrode serving as an anode pass to the cathode. It should also be noted that the prevention of the process of spontaneous oxidation of the bifunctional sodium electrode having a sufficiently high rate, which could lead to the release of a large amount of heat and, as a result, to the boiling of the liquid water-based electrolyte, an ignition of the bifunctional sodium electrode and even an explosion, ensures the safety of the claimed device. The isolation of the bifunctional sodium electrode from the liquid water-based electrolyte also plays an important role in the process of charging the electrolytic cell. Due to this, after the sodium supply at the bifunctional sodium electrode is consumed, it is possible to recover it from positively charged sodium ions in the liquid water-based electrolyte (which remained in it after the discharging process of the electrolytic cell is completed) at a normal (room) temperature. In this case, the anode donates electrons to be transferred to the bifunctional sodium electrode, which serves as a cathode when charging. For this, a negative potential is imparted to the bifunctional sodium electrode, and a positive potential is imparted to the anode, that is, the direction of the current when charging is changed to the opposite of what was when discharging. Without separating the bifunctional sodium electrode from the liquid water-based electrolyte, sodium reduction at it is impossible, since the rate of sodium reduction by electric current is always less than the rate of its dissolution in water. In addition, the potential for sodium reduction from ions is 2.66 V higher than the potential for hydrogen reduction, and as long as the bifunctional sodium electrode is immersed in the liquid water-based electrolyte, hydrogen, rather than sodium, will be reduced. For example, by using a set of essential features of the claimed device, its recharging with electric current is made possible. It should also be noted that due to the isolation of the bifunctional sodium electrode with a solid electrolyte from the liquid water-based electrolyte, the self-discharge of the electrolytic cell is practically absent, and it becomes possible to use an aqueous electrolyte at a normal (room) temperature. In this case, sodium is an energy-consuming material, for example, 79 kg of sodium release 3 kg of hydrogen and 240 kWh of electricity from water. Sodium is also an inexpensive material and is produced in large quantities commercially. In addition, it is not thrown away after consumption, but can be recovered many times by electric current. Using exactly a sodium electrode makes the inventive device inexpensive and affordable for consumers. Water is also an inexpensive material, so the use of a liquid water-based electrolyte also has a positive effect on the cost of the claimed device. In addition, about half of the chemical energy of sodium is released in the form of electric current energy in the external circuit, and the claimed device can be used to drive a car by an electric motor. The ion-permeable partition separating the cathode and the anode is a partition permeable to ions, but impermeable to liquids and gases, and therefore it prevents the oxygen released in the process of charging the cell at the anode from passing to the cathode. The ion-permeable partition thereby prevents the formation of an explosive mixture of the hydrogen that could remain near the cathode and oxygen, and excludes the occurrence of an explosive situation in the process of charging the device.

According to a preferred embodiment of the invention, the sodium electrode is made of an alloy which is liquid at a room temperature, containing from 50 to 85% sodium and from 10 to 15% potassium. When part of sodium of the bifunctional sodium electrode dissolves, the liquid alloy continues to adhere to the solid electrolyte, providing for electrical contact. The passage of positively charged sodium ions through the solid electrolyte into the liquid electrolyte, where they will accumulate, will be ensured in this way.

According to a preferred embodiment of the invention, the solid electrolyte is β-alumina. β-alumina is β-aluminum oxide (Al₂, O₂), which is essentially a mixed oxide of aluminum and sodium. β-alumina is characterized by a high sodium-ionic conductivity and provides for a reliable and high-quality isolation of the bifunctional sodium electrode from the liquid water-based electrolyte, while thanks to the sodium-ionic conductivity positively charged sodium ions pass freely therethrough and enter the liquid electrolyte. Ceramic solid electrolyte based on β-aluminum oxide can be one example of a solid electrolyte that can be used in the claimed device as the most suitable insulator isolating the bifunctional sodium electrode from the liquid electrolyte.

According to a preferred embodiment of the invention, the device comprises a transistor switch or a lamp switch installed in the external circuit. The current regulator in the external circuit is usually the ohmic resistance of this circuit (load), the value of which determines the magnitude of current in the circuit and, therefore, the rate of discharge of the electric cell. Since the main purpose of the claimed device is the production of hydrogen, it is possible to regulate the release of hydrogen by adjusting the magnitude of current in the external circuit. It is preferable (in order to save energy) to adjust current without changing the ohmic resistance of the load in the circuit, but by using a transistor switch or a lamp switch with a minimum ohmic resistance. The release of hydrogen occurs at the cathode, and the rate of its release is proportional to the magnitude of current in the external circuit in accordance with Faraday's law. The electronic switch, by adjusting the magnitude of current, automatically regulates the hydrogen flow while driving. The transfer of electrons from the bifunctional sodium electrode, which serves as an anode when the cell is discharging, to the cathode through the electronic switch allows the flow of hydrogen released at the cathode to be regulated smoothly and quickly. Hydrogen is released only when the car is on the move as it is consumed, which ensures further safety of the device.

According to a preferred embodiment of the invention, the cathode is a copper cathode. The overvoltage of hydrogen release from water is lower at the copper electrode (copper cathode) (its standard electrode potential (in an alkaline electrolyte) is +0.34 V). Therefore, it is advisable to use exactly a copper cathode for the reduction of hydrogen from a liquid water-based electrolyte as a cathode used when the electrolytic cell is discharged in a pair with a bifunctional sodium electrode serving as an anode when the cell is discharging.

According to a preferred embodiment of the invention, the anode is a carbon anode. In the claimed device, when the cell is charged in a pair with a bifunctional sodium electrode serving as a cathode, an anode is used that donates electrons to be transferred to the bifunctional sodium electrode. At the same time, oxygen is released at the anode (oxidized from a liquid water-based electrolyte or hydroxyl ions (OH⁻)), an external energy source takes electrons from the anode. Under the conditions described, only coal (graphite) and platinum metals are not subject to destruction, in other words, the carbon anode is resistant to oxidation.

The electrodes have a shape selected from the group including a plate, a cylindrical rod, a rectangular rod.

According to a preferred embodiment of the invention, the electrodes are made in the form of a plate, a rod with a round transverse.

According to a preferred embodiment of the invention, the housing of the electrolytic cell is made of glass.

According to a preferred embodiment of the invention, the electrolytic cell is provided with a hydrogen outlet branch, an oxygen outlet branch, a liquid inlet branch and a cover. The oxygen outlet branch and the hydrogen outlet branch are used to remove explosive and fire-hazardous gases from the cell. The liquid inlet branch allows water to be added to the electrolytic cell as needed. The cover is hermetic and is made of an electrical insulating material to protect the electrolytic cell from external influences.

According to a preferred embodiment of the invention, the housing of the device is made of ebonite or textolite. The housing of the device must be made of an electrically insulating, heat-resistant and chemically inert material, at the same time it must be shock-resistant, cheap and easy to manufacture. Said materials have all of the above characteristics and therefore are the most preferred for use in the design of the claimed device.

According to a preferred embodiment of the invention, the device is installed in a car.

The approximate characteristics of the device for producing hydrogen installed in a car with a mass of sodium (contained in the bifunctional sodium electrode) of about 79 kg (3 kilomoles) are as follows:
1) The total electric charge of the device (in other words, the charge of the charged electrolytic cell) is 3·10⁸ C.
2) The potential difference between the electrodes in an open circuit is 3.18 V.
3) The total energy of the system (relative to free oxygen) is 13.86·10⁸ J.
4) The mass of hydrogen produced during discharge of the electrolytic cell is 3 kg;
5) The energy produced during combustion of 3 kg of hydrogen (thermal energy) is 4.23·10⁸ J.
6) The electrical energy produced during oxidation of hydrogen in fuel cells with an efficiency of 50% is 2.115·10⁸ J.
7) The electrical energy produced in the external electrical circuit when the voltage drops on the load of 2.5 V (for each electrolytic cell) is 7.5·10⁸ J.
8) The energy that can be used to move the car (the efficiency of the electric motor is taken to be 0.9) is 8.64·10⁸ J (240 kW·h).
9) The maximum specific energy consumption for a car weighing 3 tons is 20 kW·h/100 km.
10) The average mileage of a car with a total weight of 3 tons on a single charge is 750 miles (1200 km).
11) The approximate mass of the device for producing hydrogen is 300 kg.

These alternative features, together with the other essential features of the device, provide the same result within the framework of the device according to the present invention.

The present invention also provides a method for producing hydrogen by alternating the discharging and charging processes of a rechargeable electrolytic cell with electrodes, at least partially filled with a liquid water-based electrolyte, wherein a sodium electrode isolated from the liquid electrolyte by a solid electrolyte configured to exchange positively charged sodium ions with the liquid electrolyte, a cathode and an anode are used as electrodes, wherein the passage of electrons from the sodium electrode to the cathode is provided in the discharging process to release hydrogen at the cathode, and the transfer of electrons from the anode to the sodium electrode is provided in the charging process to recover the sodium electrode by passing an electric current through the anode and the sodium electrode, wherein the cathode and the anode are separated by means of an ion-permeable partition.

The essence of the claimed method lies in the fact that the sodium electrode is not brought into direct contact with the liquid water-based electrolyte for its oxidation to sodium hydroxide. Instead, during the realization of the method, sodium is oxidized to sodium ions by donation of electrons to the external electrical circuit by neutral sodium atoms. These electrons are transferred to the cathode, where they reduce hydrogen from water. The alternation of the discharging and charging processes of the rechargeable electrolytic cell enables to produce hydrogen from water only using the energy of an electric current from an electrical network. In this case, the sodium electrode isolated from the liquid electrolyte by the solid electrolyte configured to exchange positively charged sodium ions with the liquid electrolyte is used alternately in a pair with the cathode in the discharging process, and in a pair with the anode in the charging process. The solid (waterproof) electrolyte separates the sodium electrode from the liquid water-based electrolyte (water) so that no direct (and uncontrolled) interaction of sodium with the liquid water-based electrolyte (water) occurs. The cathode, to which, in the discharging process, electrons are transferred from the sodium electrode to release hydrogen at the cathode, contacts the liquid water-based electrolyte (water). The electrons come to the cathode from an external circuit. Thus, the claimed method is a method for indirect reduction of hydrogen from water using the active metal, which distinguishes it from the known direct methods. It is important that the regulation of the rate of hydrogen release at the cathode (as well as the dissolution of sodium at the sodium electrode serving as an anode during the discharge of the electrolytic cell) is carried out by regulating the current in the external circuit (and not by dosed addition of water, as described in the prior art). Hydrogen is released at the cathode, and the release rate is proportional to the magnitude of current in the external circuit. Thus, uncontrolled hydrogen release is avoided, which means that the claimed method is a safe method for producing hydrogen. Another key point of the claimed method is the use of the energy of the difference between the standard electrode potentials of sodium and hydrogen, which is −2.66 V, for performing useful work. This means that the production of hydrogen at the (inert) cathode upon dissolution of the active anode, which is the sodium electrode during the discharge of the cell, made it possible to usefully use the said difference of electrochemical potentials between the cathode and the sodium electrode, approximately doubling the efficiency of the energy conversion system. Thanks to separation of the dissolution process of the sodium electrode and the hydrogen reduction process, an electron flow in the external electrical circuit that can perform useful work is obtained. In all methods for producing hydrogen directly described in the prior art this energy (286 kJ/mol) is converted into heat. The claimed method, in turn, is not only a method for producing hydrogen, but also a method for producing simultaneously electrical energy. About half of the chemical energy of sodium is released in the form of electric current energy in the external circuit and can be used to drive a car with an electric motor. Also, in contrast to the methods for producing hydrogen by electrolysis of water, the claimed method enables to obtain hydrogen (and electricity) not by using the energy of the electrical network in a stationary manner, but by using the energy of the sodium supply contained in the sodium electrode. After the sodium supply at the sodium electrode is depleted, electrons are transferred from the anode to the sodium electrode by passing an electric current through the anode and the sodium electrode, such that the sodium electrode is recovered in the charging process. In this case, the presence of a solid electrolyte enables to recover a bifunctional sodium electrode by electric current at a normal temperature from an alkali solution.

According to a preferred embodiment of the invention, an electric motor connected to the external circuit is used as a payload. In this case, an electric motor that drives a car can be used. It should be noted that a payload with such a resistance that the voltage drop thereon is no more than 2.5 V per one electrolytic cell, and the negative potential at the cathode is no less than 1.44 V, is used as a payload.

According to a preferred embodiment of the invention, the rate of hydrogen release is regulated by changing the magnitude of the current magnitude in the external circuit.

According to a preferred embodiment of the invention, the magnitude of the current in the external circuit is changed by means of a transistor switch or a lamp switch installed in the external circuit. The electronic switch, by adjusting the magnitude of current, automatically regulates the hydrogen release flow. Hydrogen is released as it is consumed, in particular, when the car is on the move. Therefore, a regulated and safe hydrogen release is provided when realizing the claimed method.

According to a preferred embodiment of the invention, the method is used to supply the car with hydrogen. It should be noted, however, that hydrogen is used to generate electrical energy in fuel cells, while electrical current is used to drive a car. Fuel cells are such electrochemical cells (electrical cell is an outdated name for chemical current sources—CCS) that produce electrical energy by oxidizing fuel at the electrodes. Hydrogen-oxygen fuel cells are meant in this case. They come in a variety of designs. These fuel cells oxidize hydrogen gas to water using oxygen (air) and generate electrical energy.

These alternative features, together with the other essential features of the method, provide the same result within the framework of the method according to the present invention.

Aspects of the present invention are given herein with reference to the drawings.

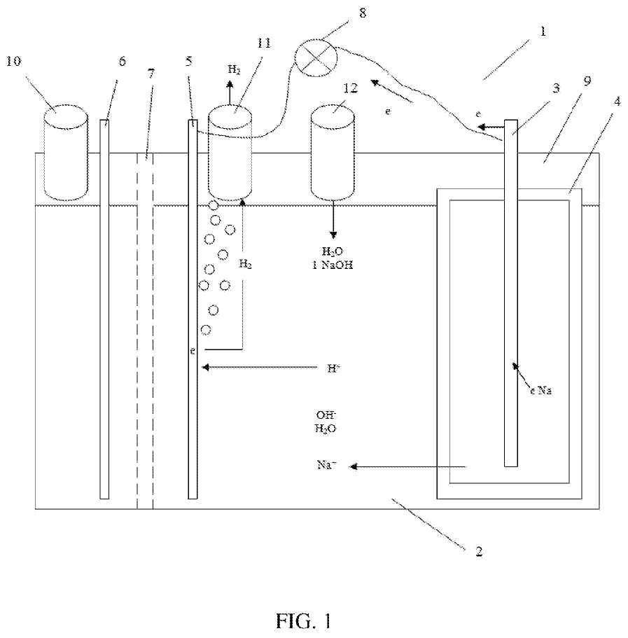

FIG. 1 shows a general view of an electrolytic cell 1 in a discharging process, filled with a liquid water-based electrolyte 2 and comprising a bifunctional sodium electrode 3 isolated from the liquid electrolyte 2 by a solid electrolyte 4, as well as a copper cathode 5 and a carbon anode 6 separated by an ion-permeable partition 7. The bifunctional sodium electrode 3 serving as an anode during discharging and the copper cathode 5 are closed on a payload 8. The electrolytic cell 1 is provided with a cover 9, an oxygen outlet branch 10, a hydrogen outlet branch 11 and a liquid inlet branch 12. The figure also shows H₂O—water, H₂—hydrogen, H⁺—positively charged hydrogen ions, e—electrons, Na—sodium, Na⁺—positively charged sodium ions, OH⁻—negatively charged hydroxyl ions, NaOH—sodium hydroxide.

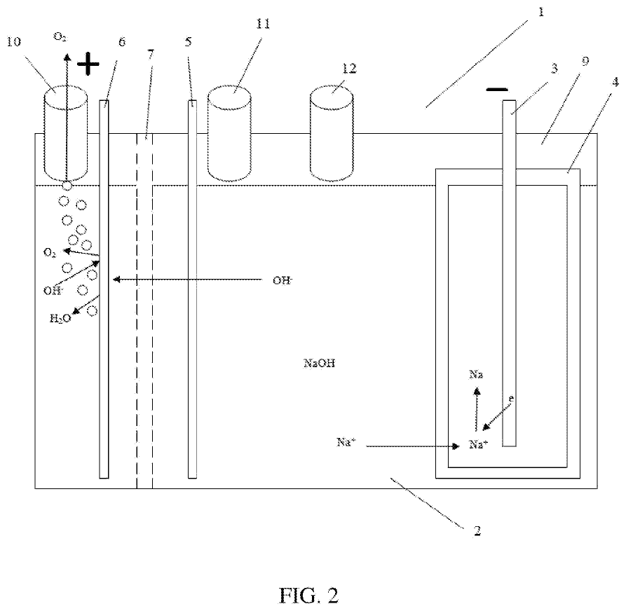

FIG. 2 shows a general view of the electrolytic cell 1 in the charging process, where the elements identical to the elements in FIG. 1 are designated with the same reference numerals. During discharging, a negative potential is imparted to the bifunctional sodium electrode 3 serving as a cathode in the charging process, and a positive potential is imparted to the carbon anode 6. O₂—oxygen—is also indicated in the figure.

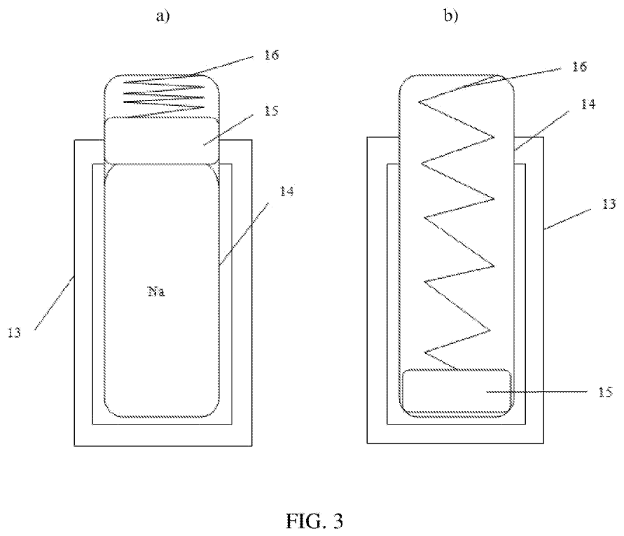

FIG. 3 shows an example of an implementation of a bifunctional sodium electrode, where a is a bifunctional sodium electrode in a charged state, b is a bifunctional sodium electrode in a discharged state. The presented bifunctional sodium electrode contains a rectangular hermetic housing 13, inside which a rectangular metallic tube 14 is located, and there is a metallic hollow thin-walled piston 15 (under which sodium (Na) is disposed) pressed by a spring 16 inside the tube.

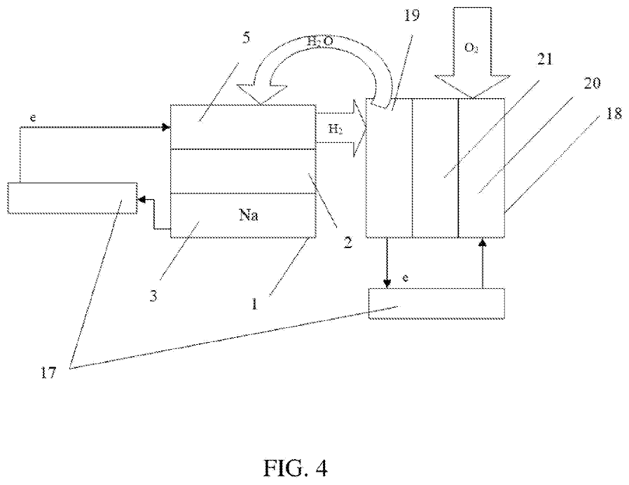

FIG. 4 shows a schematic example of combining a device for producing hydrogen with a stack of fuel cells in a car, where 1—an electrolytic cell, 17—electric motors, 18—a fuel cell, 19—an anode of the fuel cell 18, 20—a cathode of the fuel cell 18, 21—a liquid electrolyte or a solid electrolyte, in which the anode 19 and the cathode 20 of the fuel cell 18 are placed. The arrow with the inscription H_{z} in this figure indicates a flow of hydrogen gas from the electrolytic cell to the stack of fuel cells 18, the anode 19 is a negative electrode of the fuel cell 18, to which hydrogen gas is supplied. The arrow with the inscription O₂ indicates a flow of gaseous oxygen (air), which is supplied to the positive electrode (cathode 20) of the fuel cell 18. The arrow with the inscription H₂O indicates that the water produced as a result of the oxidation of hydrogen can be added (if necessary) to the electrolytic cell 1. The thin arrows in this figure indicate a flow of electrons (electric current). In this case, the elements identical to the elements in FIG. 1 are designated with the same reference numerals.

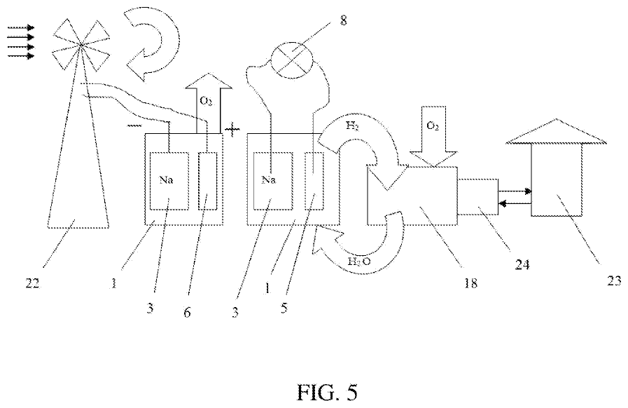

FIG. 5 shows a schematic example of combining a device for producing hydrogen and the usage of hydrogen in stationary energy storage units, where an electrolytic cell 1 is shown when being charged by a wind power plant 22, and an electrolytic cell 1 is shown when being discharged by a consumer of energy 23, wherein the fuel cells are shown with the reference numeral 18, and the inverter is shown with the reference numeral 24. In this case, the elements identical to the elements in FIG. 1, 2, 4 (including the arrows with inscriptions H₂, O₂, H₂O) are designated with the same reference numerals.

The claimed invention is realized as follows.

The claimed device for producing hydrogen comprises a housing (not shown in the figures) with compartments for electrolytic cells 1. The housing is made of ebonite or textolite. Glass electrolytic cells 1 covered with hermetic covers 9 made of an electrical insulating material are inserted into the compartments. An oxygen outlet branch, a hydrogen outlet branch and a liquid inlet branch 10, 11, 12, respectively, as well as terminals (not shown in the figures) of the electrodes 3, 5 and 6 are soldered in the covers 9. All electrolytic cells 1 are connected electrically in series to sum the potential difference from each pair of electrodes: of the bifunctional sodium electrode 3 and the copper cathode 5 for discharging, of the bifunctional sodium electrode 3 and the carbon anode 6 for charging.

Each electrolytic cell 1 is filled with an aqueous electrolyte 2 based on sodium hydroxide (NaOH) solution. The bifunctional sodium electrode 3, the copper cathode 5, the carbon anode 6 are immersed in the aqueous electrolyte 2. In this case, the bifunctional sodium electrode 3 is isolated from the aqueous electrolyte 2 by a solid electrolyte 4. The solid electrolyte 4 is an ion-exchange sodium cation exchanger made of β-alumina. Also, the solid electrolyte 4 can be made of a cationic polymer material. The copper cathode 5 and the carbon anode 6 are separated by an ion-permeable, but a gas-tight partition 7. It should be noted that partitions (diaphragms for electrolysis) can be made of asbestos board, asbestos cement, terracotta ceramics, special polymers, special gels.

In the discharging process of the electrolytic cell 1 (presented in FIG. 1) the bifunctional sodium electrode 3 serving as an anode and the copper cathode 5 are closed on a payload 8, wherein an electric current begins to flow through the external circuit. This happens because the standard electrode potential of sodium is −2.71 V, and that of copper is +0.34 V (in an alkaline environment). Therefore, the electrons (e) leave the sodium (Na) atoms and flow through the external circuit to the copper cathode 5. Sodium (Na) atoms are converted into positively charged sodium ions (Na⁺), which is shown in the chemical reaction equation (1):

Na−e=>Na⁺ (1)

In this case, the formed sodium ions (Na′) pass along the electrical field gradient through the solid electrolyte 4, go out into the liquid electrolyte 2, where they accumulate. The electrons (e) that came through the external circuit to the copper cathode 5 reduce water molecules (H₂O) to free hydrogen (H₂), which is shown in the equations of chemical reactions (2a and 2b):

2H₂O+2e=>2H+2OH⁻(−0.41V) (2a)

2H═>H₂ (2b)

Hydrogen atoms form hydrogen molecules that float upward in the form of gas bubbles (shown in FIG. 1). The bubbles release hydrogen into the cathode space above the liquid electrolyte 2, from where, according to the pressure gradient, hydrogen leaves through the hydrogen outlet branch 11 to power the internal combustion engine or for oxidation into fuel cells to generate electricity, which is shown in the chemical reaction equation (3).

2H₂+O₂=>2H₂O(1.44V) (3)

As water flows into the electrolytic cell 1 (into the liquid electrolyte 2 contained in the cell), distilled water from the system of condensation of water vapor, which is a product of hydrogen oxidation by air oxygen in the engine or fuel cells, is automatically added through the inlet branch 12. Positively charged sodium ions (Na⁺) and negatively charged hydroxyl ions OH⁻ form sodium hydroxide (NaOH), as shown in the chemical reaction equation (4), and remain in the liquid electrolyte 2:

Na⁺+OH⁻<=>NaOH (4)

After the dissolution of all sodium in the bifunctional sodium electrode 3, the discharging process stops. For the device to return to its original state, it is recharged.

The process of charging the electrolytic cell 1 (presented in FIG. 2) occurs when an electric current is passed through the electrolyte (2 and 4) in the opposite direction. Voltage is applied not to the copper cathode 5, but to the carbon anode 6, separated from it by the ion-permeable partition 7, thereby avoiding the ingress of oxygen into the hydrogen outlet branch 11 and preventing the formation of the explosive mixture. A positive potential (+) is applied to the carbon anode 6. In this case, negatively charged hydroxyl ions are discharged on it OH⁻, and oxygen is oxidized to a free state O₂, which is shown in the chemical reaction equation (5):

4OH⁻−4e=>O₂+2H₂O (5)

Oxygen is released in the form of gas bubbles (shown in FIG. 1) and leaves through the oxygen outlet branch 10 to the atmosphere. The carbon anode 6, thanks to the material it is made from, is not oxidized when oxygen is released on it.

A negative potential (−) is applied to the bifunctional sodium electrode 3, and it serves as a cathode when the electrolytic cell is charging. The cations (positively charged sodium ions) that came to the bifunctional sodium electrode 3 from the liquid electrolyte 2 through the solid electrolyte 4 are discharged on it. Taking an electron (e), positively charged sodium ions (Na⁺) become neutral sodium (Na) atoms and accumulate inside the housing of the solid electrolyte 4 (the so-called sodium chamber), which is shown in the chemical reaction equation (6):

Na⁺+e=>Na (6)

Thus, alkali (sodium hydroxide, NaOH) from the liquid electrolyte 2 is spent to reduce metallic sodium and oxidize oxygen to its original states, and its concentration in the liquid electrolyte 2 decreases. After completion of the charging process, the device for producing hydrogen is ready for operation again. At the same time, the device withstands 1000 charge-discharge cycles, that is, when used with a car, it allows it to drive 1200000 km without replacement.

It should be noted that the example of implementation of the bifunctional sodium electrode 3 presented in FIG. 3 enables to change the sodium mass (and hence the volume) in the processes of discharging and charging the electrolytic cell 1. The bifunctional sodium electrode 3 is made in the form of a rectangular hermetic housing 13 without a top cover, made of a solid sodium cation exchanger, for example, β-alumina. Thus, the housing 13 made of β-alumina of the bifunctional sodium electrode 3 essentially is and serves as a solid electrolyte. A rectangular metallic tube 14 is located inside the housing 13 with a gap of 2-3 mm, and a metallic hollow thin-walled piston 15 can move inside the tube. The piston 15 is pressed from above by a spring 16, which imparts some force to it. The upper hermetic cover (not shown in FIG. 3) of the housing 13 is the upper stop of the spring 16. The free space under the cover is filled with helium or argon under slight overpressure to prevent sodium from being oxidized. An alloy of sodium and potassium is disposed under the piston 15, preferably in a percentage ratio of 85:15. The addition of potassium is needed for the alloy to be liquid in the operating temperature range (40-60° C.). The more sodium is consumed, the higher is the concentration of potassium in it, and the lower is the melting point of the sodium-potassium alloy. In the range of 70-80% of potassium, the melting point of the eutectic is about −12° C. When the bifunctional sodium electrode 3 is charged (FIG. 3 a)), the piston 15 is in the upper position. As sodium is depleted, its volume decreases, and the piston 15 moves downward, squeezing liquid sodium into the gap between the walls of the tube and the housing 13 made of β-alumina serving as a solid electrolyte. Thus, the sodium level near the walls of the housing 13 made of β-alumina is maintained all the time, and the contact area of sodium with β-alumina (solid electrolyte) is maximal. This enables to maintain a maximum rate of ion exchange through β-alumina (solid electrolyte) regardless of the extent of sodium depletion.

When the bifunctional sodium electrode 3 is discharged (FIG. 3 b)), the piston 15 is in the lower position. At that time, all the residual liquid sodium is in the gap between the walls of the metallic tube 14 and the housing 13 made of β-alumina. It enables to maintain a maximum current strength when the electrolytic cell 1 is charged. The metallic tube 14 can be made of stainless steel and serve as a conductive base for the bifunctional sodium electrode 3.

The most successful combination of the claimed invention for producing hydrogen is the one with a stack of fuel cells 18 in the car. In this configuration, the car can be driven by electric motors 17 (FIG. 4).

In this case, the claimed method for producing hydrogen can be used not only to supply cars with hydrogen, but also in stationary energy storage units. In an interpeak period, energy from the network is stored to compensate for peak loads. In this case, the hydrogen feeder is combined with the stack of fuel cells 18, the inverter 24, and possibly the alternative energy generator 22 (FIG. 5).

It should be understood that the claimed method for producing hydrogen and the device for producing hydrogen, which realizes said method, as defined in the appended claims, are not necessarily limited to the specific features and embodiments described above. Rather, the specific features and embodiments described above are disclosed as examples realizing the claims, and other equivalent features can be covered by the claims of the invention.

Thus, the present invention is an autonomous, safe, cheap, durable and compact device for producing hydrogen, the design of which allows it to be recharged by recovering the sodium electrode, which is a source of electrons for hydrogen generation, at a normal (room) temperature, prevents the corrosion of the electrode, which occurs during contact with a liquid water-based electrolyte, and ensures that the device retains its charge for a long time. In addition, the present invention is a method for producing hydrogen that provides for the degree of safety and ease of realization required for common use, in particular, by allowing it to be realized at a normal (room) temperature and allowing the rate of hydrogen release to be regulated, and allows the sodium electrode, which is a source of electrons for hydrogen generation, to be recovered.

1. A device for producing hydrogen, comprising:
a housing; and
and at least one rechargeable electrolytic cell with a plurality of electrodes, mounted in the housing, the plurality of electrodes include an anode and a cathode, the electrolytic cell further being at least partially filled with a liquid water-based electrolyte,
wherein the device comprises a sodium electrode isolated from the liquid electrolyte by a solid electrolyte configured to exchange positively charged sodium ions with the liquid electrolyte.

2. The device of claim 1, wherein the sodium electrode is a bifunctional sodium electrode serving as the anode when the cell is discharging and serving as a cathode when the cell is charging, wherein the cathode is a cathode, at which hydrogen is released during the passage of electrons from the bifunctional sodium electrode to the cathode when the cell is discharging, and the anode is an anode that donates electrons to be transferred to the bifunctional sodium electrode when the cell is charging.

3. The device of claim 1, wherein the sodium electrode is made of an alloy which is liquid at a room temperature, containing from 50 to 85% sodium and from 15 to 50% potassium.

4. The device of claim 1, wherein the solid electrolyte is β-alumina.

5. The device of claim 1 further comprising a transistor switch or a lamp switch installed in the external circuit.

6. The device of claim 1, wherein the cathode is a copper cathode.

7. The device of claim 1, wherein the anode is a carbon anode.

8. The device of claim 1, wherein the electrolytic cell housing is made of glass.

9. The device of claim 1, wherein the electrolytic cell is provided with a hydrogen outlet branch, an oxygen outlet branch, a liquid inlet branch and a cover.

10. The device of claim 1, wherein the housing is made of ebonite or textolite.

11. The device of claim 1, wherein the housing and the at least one rechargeable electrolytic cell are installed in a car.

12. A method for producing hydrogen by alternating a discharging process and a charging process of a rechargeable electrolytic cell with electrodes, at least partially filled with a liquid electrolyte, the method comprising:
providing a cathode and an anode as the electrodes;
isolating a sodium electrode from the liquid electrolyte by a solid electrolyte configured to exchange positively charged sodium ions with the liquid electrolyte;
transferring of electrons from the sodium electrode to the cathode in the discharging process to release hydrogen at the cathode; and
transferring of electrons from the anode to the sodium electrode in the charging process to recover the sodium electrode by passing an electric current through the anode and the sodium electrode, wherein the cathode and the anode are separated by means of an ion-permeable partition.

13. The method of claim 12, wherein an electric motor connected to an external circuit is used as a payload.

14. The method of claim 12, wherein a rate of hydrogen release is regulated by changing the magnitude of the current in the external circuit.

15. The method of claim 13, wherein the magnitude of the current in the external circuit of an electrical energy source is changed by means of a transistor switch or a lamp switch installed in the external circuit.

16. The method of claim 12 being conducted to supply a car with hydrogen.

17. The device of claim 1, wherein the cathode and the anode are separated by an ion-permeable partition.

18. A device for producing hydrogen, comprising:
a housing; and
at least one rechargeable electrolytic cell with a plurality of electrodes mounted in the housing, the plurality of electrodes includes an anode, a cathode, and a sodium electrode, wherein the rechargeable electrolytic cell further being at least partially filled with a liquid water-based electrolyte,
wherein the sodium electrode is isolated from the liquid water-based electrolyte by a solid electrolyte configured to exchange positively charged sodium ions with the liquid water-based electrolyte.

19. The device of claim 18, wherein the cathode and the anode are separated by an ion-permeable partition.

20. The device of claim 1, wherein the rechargeable electrolytic cell is deployed within a car and provided with a hydrogen outlet branch, an oxygen outlet branch, a liquid inlet branch and a cover.
